(19) United States
(12) Patent Application Publication
(10) Pub. No.: US 2026/0335919 A1
(43) Pub. Date: Oct. 29, 2026

(54) DEVICE FOR COATING CAT LITTER WITH MOISTURE

(71) Applicant: JL C&T CO., LTD., Anseong-si Gyeonggi-do (KR)

(72) Inventor: Younghoon SONG, Suwon-si (KR)

(73) Assignee: JL C&T CO., LTD., Anseong-si Gyeonggi-do (KR)

(21) Appl. No.: 19/697,903

(22) Filed: Jun. 4, 2026

Related U.S. Application Data
(63) Continuation of application No. PCT/KR2024/017243, filed on Nov. 5, 2024.

(30) Foreign Application Priority Data
Dec. 8, 2023 (KR) 10-2023-0177227
Jun. 4, 2024 (KR) 10-2024-0072894

(51) Int. Cl. B05B 13/02; A01K 1/015; B05B 9/03

(52) U.S. Cl. CPC B05B 13/0257; A01K 1/0152; B05B 9/03

(57) ABSTRACT

A device for coating cat litter with moisture. The device for coating cat litter with moisture includes a raw material inlet, a raw material outlet, and a moisture coating module. When a raw material is introduced into the moisture coating module through the raw material inlet, the introduced raw material is coated with moisture by water sprayed thereto through the moisture coating module, and the moisture-coated raw material is discharged through the raw material outlet.

### TECHNICAL FIELD

Various embodiments of the present invention relate to a device for coating cat litter with moisture, and more particularly, to a device for coating cat litter with moisture that supplies (sprays) moisture onto cat litter (for example, bentonite) and coats a surface of the cat litter with the moisture, thereby minimizing dust from the cat litter.

### BACKGROUND

Conventionally, companion animals have been raised for commercial purposes and have been raised in cages set up in specific outdoor locations rather than in indoor spaces. However, in modern society, the perception of companion animals has shifted, and they are now recognized as members of the family rather than merely animals. In particular, the adoption of companion animals is expanding as a means of gaining familiarity with nature and animals in urban areas, understanding nature through interaction, and enhancing the quality of life, and the demand for companion animals is steadily increasing in diverse ways among animal lovers and enthusiasts.

Cats, which are representative companion animals, are increasingly trending toward being recognized as family members and lifelong companions rather than merely animals, and accordingly, the cat supplies market is also developing in diverse ways. In particular, cat litter is an essential item that plays a critical role in maintaining a clean living environment for cats.

Unlike other companion animals, cats have a tendency to bury their urine and feces in litter, and thus, litter (also known as cat litter) is essential for disposal of urine and feces, and without the litter, cats are unable to defecate or urinate properly.

Cat litter is broadly classified into absorbent and clumping types and is used according to the characteristics of each.

Here, the absorbent litter is a product having a function of absorbing cat waste, especially urine, and representative examples include absorbent litter made of silica (SiO₂19 2H₂O), absorbent litter made of paper, and absorbent litter made of grains such as corn or soybeans. Litter produced by crushing sodium-based bentonite extracted from mines is used as the clumping litter.

Meanwhile, cat litter is used merely to demarcate the floor and conceal excrement, lacking functional properties. When used for a long period, cat litter crumbles due to drying and generates fine particles that are easily blown away by wind and serve as a primary cause of indoor air pollution, and there is a problem that damage caused by dust is significant.

The aforementioned background technology is technical information possessed by the inventor for derivation of the present invention or acquired by the inventor during the derivation of the present invention, and is not necessarily prior art disclosed to the public before the application of the present invention.

### SUMMARY

The present invention has been made in an effort to solve the above-described problems and is directed to providing a device for coating cat litter with moisture that supplies (sprays) moisture onto cat litter (for example, bentonite) and coats a surface of the cat litter with the moisture, thereby minimizing dust from the cat litter.

The objects of the present invention are not limited to that mentioned above, and other unmentioned objects can be clearly understood by those of ordinary skill in the art from the description below.

One embodiment of the present invention for achieving the above object provides a device for coating cat litter with moisture, the device including a raw material inlet, a raw material outlet, and a moisture coating module, wherein, when a raw material is introduced into the moisture coating module through the raw material inlet, the introduced raw material is coated with moisture by water sprayed thereto through the moisture coating module, and the moisture-coated raw material is discharged through the raw material outlet.

In various embodiments, the moisture coating module may include a body portion having a cylindrical shape and of which one side is connected to the raw material inlet and the other side is connected to the raw material outlet, a guide portion that is provided on an inner side surface of the body portion and guides the raw material introduced into the body portion toward the raw material outlet, and a water spray portion that is inserted into the body portion and sprays water to the raw material introduced into the body portion.

In various embodiments, the body portion may rotate in a predetermined direction, and a rotational speed of the body portion may be determined based on an amount of the raw material introduced into the body portion.

In various embodiments, the guide portion may include a first guide portion that provided on the inner side surface of the body portion and has a helical blade shape, thereby forming a movement path of the raw material introduced into the body portion, and in response to the body portion rotating in the predetermined direction, the first guide portion may guide the raw material introduced into the body portion toward the raw material outlet along the formed movement path.

In various embodiments, the guide portion may further include a second guide portion that is provided on the inner side surface of the body portion, is disposed on the formed movement path, and has a shape that is tilted a predetermined angle based on a center of the body portion, and in response to the body portion rotating in the predetermined direction, the second guide portion may guide mixing of the raw material moving along the formed movement path.

In various embodiments, the water spray portion may include a water supply portion, a valve for controlling a water supply amount of the water supply portion, and a nozzle for spraying water supplied from the water supply portion to an interior of the body portion.

In various embodiments, the water spray portion may further include an air supply portion, air supplied through the air supply portion and water supplied through the water supply portion may be sprayed through the nozzle, thereby expanding a spray range of the water, and a supply amount of the water supplied through the water supply portion and a supply amount of the air supplied through the air supply portion may be determined based on a type and an introduced amount of the raw material introduced into the body portion.

In various embodiments, the water spray portion may further include an air supply portion, and when a difference between an amount of the raw material introduced through the raw material inlet and an amount of the raw material discharged through the raw material outlet exceeds a predetermined threshold value, air supplied from the air supply portion may be sprayed through the nozzle.

In various embodiments, the nozzle may have an angle-adjustable structure and may spray water in a direction perpendicular to the raw material introduced into the body portion.

In various embodiments, the moisture coating module may include a body portion having a cylindrical shape and of which one side is connected to the raw material inlet and the other side is connected to the raw material outlet and a plurality of water spray portions that are inserted into the body portion and spray water to the raw material introduced into the body portion, and the plurality of water spray portions may be continuously arranged while intersecting each other in the body portion, thereby expanding a spray range of the water.

Other specific details of the present invention are included in the detailed description and drawings.

According to various embodiments of the present invention, it is possible to provide a device for coating cat litter with moisture that can minimize dust from the cat litter by supplying (spraying) moisture onto cat litter (for example, bentonite) and coating a surface of the cat litter with the moisture.

The effects of the present invention are not limited to the effects mentioned above, and other unmentioned effects will be clearly understood by those of ordinary skill in the art from the description below.

### BRIEF DESCRIPTION OF DRAWINGS

The following drawings attached herein illustrate preferred embodiments of the present invention by example and serve to enable technical concepts of the present invention to be further understood together with detailed description of the invention given below, and therefore the present invention should not be interpreted only with matters in such drawings.

FIG. 1 is a view illustrating a cat litter manufacturing system according to one embodiment of the present invention.

FIG. 2 is a view illustrating a device for coating cat litter with moisture that is included in the cat litter manufacturing system in various embodiments.

FIG. 3 is a block diagram illustrating components of the device for coating cat litter with moisture that are applicable to various embodiments.

FIG. 4 is a view illustrating an interior of a body portion included in a moisture coating module of the device for coating cat litter with moisture in various embodiments.

FIGS. 5 to 7 are views illustrating a guide portion included in the moisture coating module of the device for coating cat litter with moisture in various embodiments.

FIGS. 8 to 10 are views illustrating a water spray portion included in the moisture coating module of the device for coating cat litter with moisture in various embodiments.

FIG. 11 is a view illustrating a cat litter supply device included in the cat litter manufacturing system in various embodiments.

FIG. 12 is a view illustrating a cat litter packaging device included in the cat litter manufacturing system in various embodiments.

FIG. 13 is a flowchart for describing a method of coating cat litter with moisture according to another embodiment of the present invention.

FIG. 14 is a view illustrating a hardware configuration of a computing device according to still another embodiment of the present invention.

### DETAILED DESCRIPTION

Advantages and features of the present invention and methods of achieving them should become clear with embodiments described in detail below with reference to the accompanying drawings. However, the present invention is not limited to the embodiments disclosed below and may be implemented in various different forms. The present embodiments are only provided to make the disclosure of the present invention complete and completely inform those of ordinary skill in the art to which the present invention pertains of the scope of the present invention. The present invention is defined only by the scope of the claims.

Terms used herein are for describing the embodiments and are not intended to limit the present invention. In this specification, a singular expression includes a plural expression unless the context clearly indicates otherwise. The terms “comprises” and/or “comprising” used herein do not preclude the presence or addition of one or more components other than those mentioned.

Throughout the specification, the same reference numerals denote the same components, and the term “and/or” includes any and all combinations of one or more of the mentioned components. Although the terms “first,” “second,” etc., are used to describe various components, the components are not limited by these terms. These terms are only used to distinguish one component from another component. Therefore, a first component mentioned below may also be a second component within the technical idea of the present invention.

The terms “portion” or “module” used herein mean software or a hardware component such as a field programmable gate array (FPGA) or an application specific integrated circuit (ASIC), and the “portion” or “module” plays certain roles. However, the “portion” or “moule” is not limited to software or hardware. The “portion” or “module” may be constituted in a storage medium that may perform addressing or may be configured to reproduce one or more processors. Therefore, as one example, the “portion” or “module” includes components such as software components, object-oriented software components, class components, and task components, processes, functions, attributes, procedures, subroutines, program code segments, drivers, firmware, micro codes, circuits, data, databases, data structures, tables, arrays, or parameters. The components and the functions provided in the “portions” or “modules” may be combined into smaller numbers of components and “portions” or “modules” or may be further separated into larger numbers of components and “portions” or “modules.”

Spatially relative terms, such as “below,” “beneath,” “lower,” “above,” “upper” and the like, may be used herein for ease of description to describe one component or feature's relationship to another component(s) or feature(s) as illustrated in the figures. The spatially relative terms should be understood as encompassing different orientations of the components in use or operation in addition to the orientation depicted in the figures. For example, if the component in the figures is turned over, components described as “below” or “beneath” other components may be placed “above” other components. Thus, the illustrative term “below” or “beneath” can encompass an orientation of both below and above. The components may be oriented in different directions, and accordingly, the spatially relative terms may be interpreted according to orientations.

The expressions “first,” “second,” etc., used herein are used to distinguish one element from another element when referring to a plurality of elements of the same kind, and are not intended to limit the order or importance of the corresponding elements unless the context clearly indicates otherwise.

The expressions such as “A, B, and C,” “A, B, or C,” “A, B, and/or C,” “at least one of A, B, and C,” “at least one of A, B, or C,” “at least one of A, B, and/or C,” “at least one selected from “A, B, and C,” “at least one selected from “A, B, or C,” “and “at least one selected from A, B, and/or C” may mean each of the listed items or all possible combinations of the listed items. For example, “at least one selected from A and B” may refer to any of (1) A, (2) at least one A, (3) B, (4) at least one B, (5) at least one A and at least one B, (6) at least one A and B, (7) at least one B and A, and (8) A and B.

As used herein, the expression “based on” is used to describe one or more factors that influence the action or operation of a decision and judgment, described in a phrase or sentence including the expression, and the expression does not exclude additional factors that may influence the action or operation of the decision and judgment.

As used in the present specification, the expression that a certain component (e.g., a first component) is “connected” or “linked” to another component (e.g., a second component) may mean not only that the certain component is directly connected or linked to the other component but also that the certain component is connected or linked to the other component via another new component (e.g., a third component).

The expression “configured to” as used in this specification may have meanings such as “set to,” “having the ability to,” modified to,” “made to,” and “to do” depending on the context. This expression is not limited to the meaning of “specifically designed in hardware,” and for example, a processor configured to perform a specific operation may mean a generic-purpose processor capable of performing the specific operation by executing software.

Unless otherwise defined, all terms (including technical and scientific terms) used herein may be used with meanings that may be generally understood by those of ordinary skill in the art to which the present invention pertains. In addition, terms defined in commonly used dictionaries should not be interpreted in an idealized or overly formal sense unless expressly so defined herein.

In this specification, a computer denotes all types of hardware devices including at least one processor and may be understood as also encompassing software configurations operating in a corresponding hardware device according to embodiments. For example, a computer may be understood as, but is not limited to, a meaning including all of a smartphone, a tablet personal computer (PC), a desktop computer, a laptop computer, and a user client and an application running on each device.

Hereinafter, embodiments of the present invention will be described in detail with reference to the accompanying drawings.

Each step described in this specification is described as being performed by a computer, but the subject of each step is not limited thereto. At least a part of each step may be performed in different devices according to embodiments.

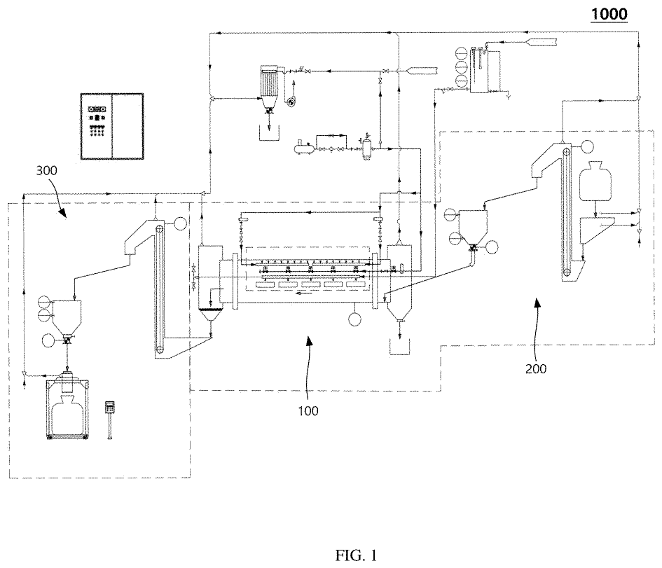

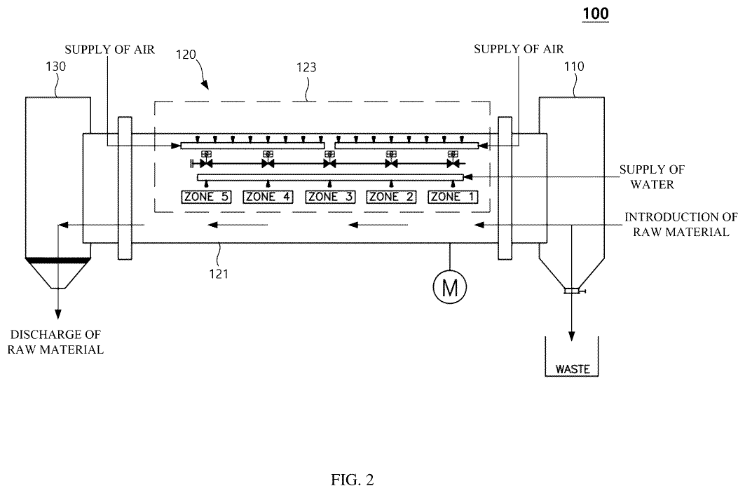

FIG. 1 is a view illustrating a cat litter manufacturing system according to one embodiment of the present invention.

Referring to FIG. 1, a cat litter manufacturing system 1000 according to one embodiment of the present invention may include a cat litter moisture coating device 100, a cat litter supply device 200, and a cat litter packaging device 300.

Here, the cat litter manufacturing system 1000 illustrated in FIG. 1 is according t one embodiment, and the components thereof are not limited to the embodiment illustrated in FIG. 1 and may be added, changed, or omitted as necessary. For example, although the cat litter manufacturing system 1000 illustrated in FIG. 1 is illustrated as including the cat litter moisture coating device 100 and the cat litter supply device 200 as individual and independent devices, the cat litter moisture coating device 100 and the cat litter supply device 200 may be implemented as a single cat litter moisture coating device in some cases.

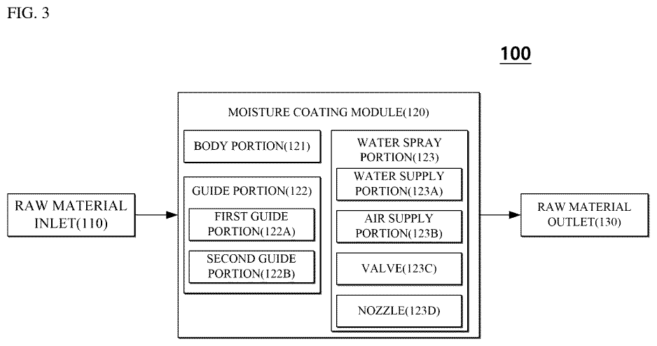

In one embodiment, the cat litter moisture coating device 100 may coat a raw material with moisture. To this end, as illustrated in FIG. 3, the cat litter moisture coating device 100 may include a raw material inlet 110, a moisture coating module 120, and a raw material outlet 130. However, the present invention is not limited thereto.

Here, the raw material may be bentonite used as cat litter, but the present invention is not limited thereto.

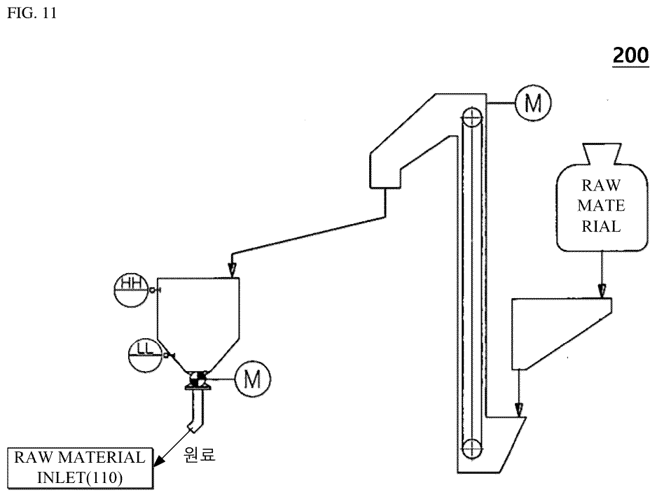

First, the raw material inlet 110 may be connected to the cat litter supply device 200 as illustrated in FIG. 11, may receive a raw material supplied from the cat litter supply device 200, and may introduce the raw material into the moisture coating module 120.

At this time, the raw material inlet 110 may perform a preceding sedimentation operation for filtering the raw material supplied from the cat litter supply device 200 N times and may primarily filter out foreign matter (waste) included in the raw material through the preceding sedimentation operation.

Next, the moisture coating module 120 may have one side connected to the raw material inlet 110 and the other side connected to the raw material outlet 130. When a raw material is introduced into the moisture coating module 120 through the raw material inlet 110, the moisture coating module 120 may spray moisture onto the raw material introduced thereinto, may coat the raw material with the moisture, and may transfer the moisture-coated raw material to the raw material outlet 130 so that the moisture-coated raw material can be discharged to the outside. To this end, the moisture coating module 120 may include a body portion 121, a guide portion 122, and a water spray portion 123, but the present invention is not limited thereto.

The body portion 121 may have a cylindrical shape and may have one side connected to the raw material inlet 110 and the other side connected to the raw material outlet 130. For example, the body portion 121 may have a cylindrical shape having a length of 5 m and a radius of 1.8 m. In another example, the body portion 121 may have a cylindrical shape having a radius of 900π to coat 3 tons of raw materials with moisture per hour. However, the present invention is not limited thereto.

The body portion 121 may rotate in a predetermined direction. To this end, the moisture coating module 120 may further include a rotating member (for example, a motor, etc.) for rotating the body portion 121 in the predetermined direction.

Here, a rotational speed of the body portion 121 may be a preset value, but the present invention is not limited thereto, and in some cases, the rotational speed of the body portion 121 may be determined based on the amount of raw material introduced into the body portion 121, that is, the amount of cat litter to be coated with moisture.

An inner side surface of the body portion 121 may be coated with a separate material (for example, Teflon (polytetrafluoroethylene (PTFE)), silicone, ceramic, epoxy, and the like) for the purpose of preventing the raw material and/or the moisture-coated raw material from sticking to the inner side surface of the body portion 121, but the present invention is not limited thereto.

The guide portion 122 may be provided on the inner side surface of the body portion 121 and may guide movement of the raw material to allow the raw material introduced into the body portion 121 to smoothly move from the raw material inlet 110 toward the raw material outlet 130. To this end, the guide portion 122 may include a first guide portion 122A and a second guide portion 122B.

The first guide portion 122A may be provided on the inner side surface of the body portion 121 and may have a helical blade shape, thereby forming a movement path of the raw material introduced into the body portion 121.

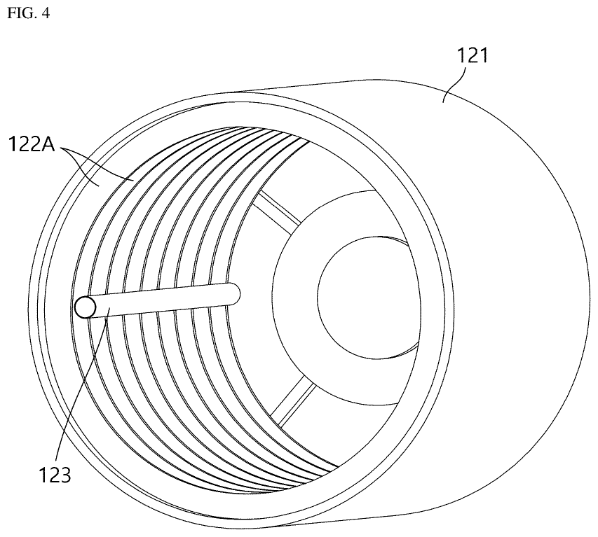

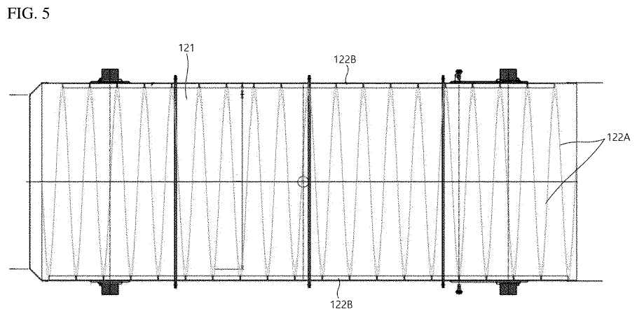

Here, the movement path of the raw material is generated by the first guide portion 122A and may mean a path along which the raw material moves in response to the rotation of the body portion 121. For example, as illustrated in FIGS. 4 and 5, the first guide portion 122A may be provided in the shape of screw threads, and areas of screw roots formed by the screw threads may serve as the movement path of the raw material, but the present invention is not limited thereto.

That is, in response to the body portion 121 rotating in the predetermined direction, the first guide portion 122A may guide the raw material introduced into the body portion 121 so that the raw material moves toward the raw material outlet 130 along the movement path of the raw material.

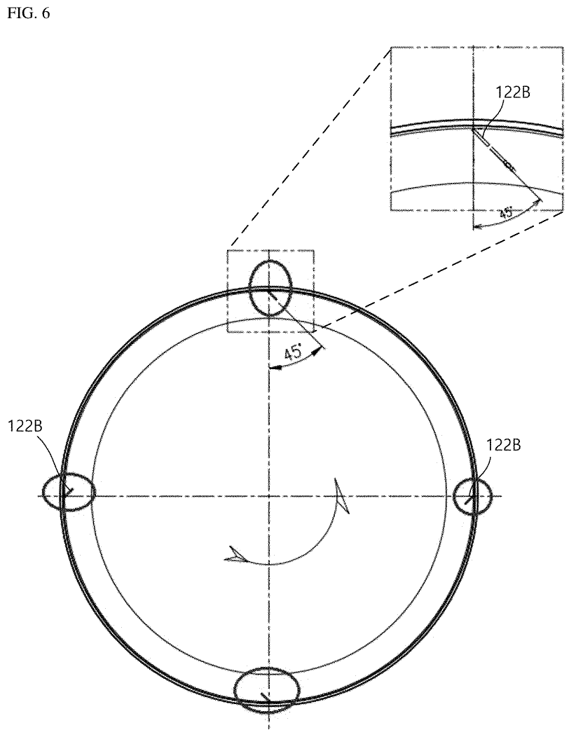

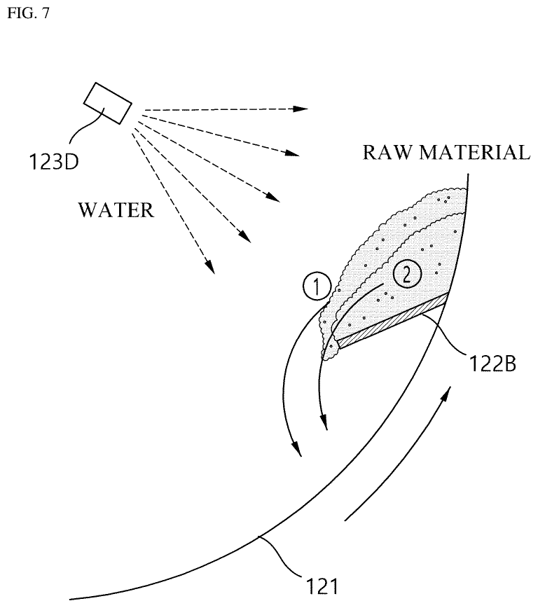

The second guide portion 122B may be provided on the inner side surface of the body portion 121 and may be disposed on the movement path formed by the first guide portion 122A. For example, as illustrated in FIGS. 6 and 7, the second guide portion 122B may be disposed on the movement path formed by the first guide portion 122A and may have a shape that is tilted a predetermined angle (for example, 45°) based on the center of the body portion 121.

Due to the second guide portion 122B having the shape that is tilted a predetermined angle, as the body portion 121 rotates, an upper end portion (\textcircled{1}) of the moisture-coated raw material moves first, and accordingly, a lower end portion (\textcircled{2}) of the raw material is exposed to the water spray portion 123, and the overall raw material can be coated with moisture.

That is, due to the second guide portion 122B having the shape that is tilted a predetermined angle, vortices may be generated in a direction opposite to the main current moving in a predetermined direction, and in this way, the moisture-coated raw material can be naturally mixed with the raw material not coated with moisture.

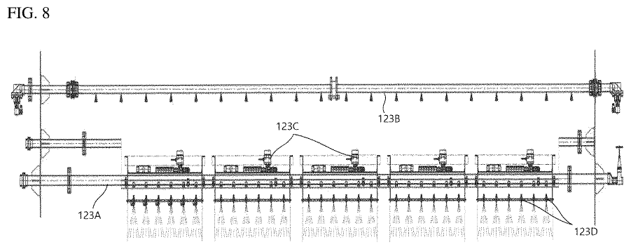

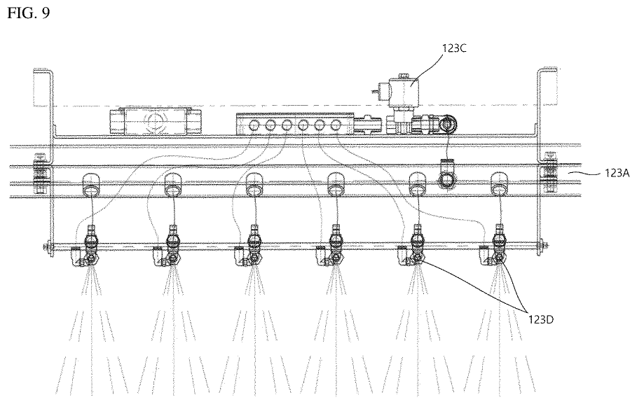

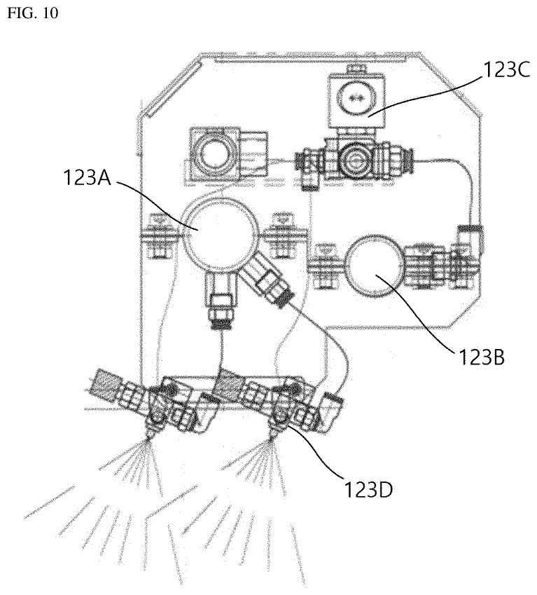

The water spray portion 123 may be inserted into the body portion 121 and may spray water to the raw material introduced into the body portion 121. To this end, the water spray portion 123 may include a water supply portion 123A, an air supply portion 123B, a valve 123C, and a nozzle 123D as illustrated in FIGS. 8 to 10, but the present invention is not limited thereto.

The water supply portion 123A may be connected to an external water supply device (for example, a water tank) and may supply water supplied from the external water supply device to the nozzle 123D.

The air supply portion 123B may be connected to an external air supply device (for example, an air compressor) and may supply air supplied from the external air supply device to the nozzle 123D.

The valve 123C may be connected to the water supply portion 123A and may adjust the water supply amount of the water supply portion 123A. In addition, the valve 123C may be connected to the air supply portion 123B and may adjust the air supply amount of the air supply portion 123B.

At this time, the water supply amount and/or the air supply amount adjusted by the valve 123C may be determined based on the type and introduced amount of the raw material introduced into the body portion 121, but the present invention is not limited thereto.

The nozzle 123D may spray the water supplied from the water supply portion 123A and/or the air supplied from the air supply portion 123B to the inside of the body portion 121. For example, the nozzle 123D may spray only the water supplied from the water supply portion 123A to the raw material, but the present invention is not limited thereto, and the nozzle 123D may spray the water supplied from the water supply portion 123A and the air supplied from the air supply portion 123B together and may expand a spray range of the water, thereby allowing the water to be sprayed in a wider range in the body portion 121.

The nozzle 123D may be an atomizing nozzle and may supply moisture by atomizing water particles and spraying the atomized water particles to cat litter.

In various embodiments, a single water supply portion 123A may include a plurality of nozzles 123D (e.g., thirty nozzles), and each nozzle 123D may spray 5 L of water at maximum per hour. Here, the plurality of nozzles 123D may be installed at different positions of the body portion 121 in a zigzag form to secure a widest possible moisture spray angle and increase a wetting range and a wetting coverage.

In addition, when it is determined that the raw material is unable to smoothly move in the body portion 121, the nozzle 123D may spray only the air supplied from the air supply portion 123B and may prevent the raw material from being adhered to the inner side surface of the body portion 121, being unable to move, and interfering with a smooth movement flow of the raw material.

The nozzle 123D may have a structure of which an angle and/or a direction is adjustable (for example, a hinge structure), the angle and/or direction of the nozzle 123D may be adjusted so that water is sprayed in a direction perpendicular to the raw material introduced into the body portion 121.

Here, the nozzle 123D may indicate a single nozzle or may indicate a plurality of nozzles disposed in an array form.

Here, although the moisture coating module 120 is illustrated as including a single water spray portion 123 in FIG. 3, the present invention is not limited thereto, and the moisture coating module 120 may include a plurality of water spray portions 123, and the plurality of water spray portions 123 may be continuously arranged while intersecting each other (for example, arranged in a zigzag form) in the body portion 121 to expand the spray range of water.

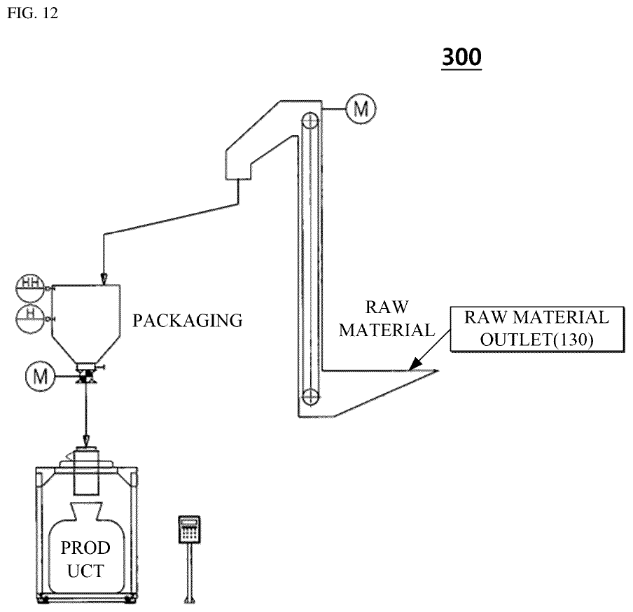

Next, the raw material outlet 130 may be connected to the cat litter packaging device 300 as illustrated in FIG. 12, may receive the raw material coated with moisture through the moisture coating module 120, and may supply the raw material to the cat litter packaging device 300.

At this time, when a difference between the amount of the raw material introduced through the raw material inlet 110 and the amount of the raw material discharged through the raw material outlet 130 exceeds a predetermined threshold value, air supplied from the air supply portion 123B may be sprayed through the nozzle 123D.

In addition, the raw material outlet 130 may perform a succeeding sedimentation operation for filtering the raw material coated with moisture through the moisture coating module 120 N times and may secondarily filter out foreign matter (waste) included in the raw material through the succeeding sedimentation operation.

In one embodiment, the cat litter supply device 200 may be connected to the cat litter moisture coating device 100 and may supply the raw material to be coated with moisture to the cat litter moisture coating device 100. For example, as illustrated in FIG. 11, the cat litter supply device 200 may include a first raw material introduction hopper into which the raw material to be coated with moisture is introduced, a bucket elevator that lifts/lowers the raw material introduced into the first raw material introduction hopper, a second raw material introduction hopper into which the raw material transported through the bucket elevator is introduced and which supplies the raw material to the raw material inlet 110 of the cat litter moisture coating device 100, and a rotary valve that adjusts the supply amount of the raw material supplied from the second raw material introduction hopper, but the present invention is not limited thereto.

In one embodiment, the cat litter packaging device 300 may be connected to the cat litter moisture coating device 100 and may package and commercialize the raw material coated with moisture through the cat litter moisture coating device 100. For example, as illustrated in FIG. 12, the cat litter packaging device 300 may include a bucket elevator that is connected to the raw material outlet 130, receives the raw material discharged from the raw material outlet, and lifts/lowers the raw material, a packaging hopper into which the raw material transported through the bucket elevator is introduced, a rotary valve that adjusts the supply amount of the raw material supplied through the packaging hopper, and a packaging module that packages the raw material supplied through the packaging hopper, but the present invention is not limited thereto.

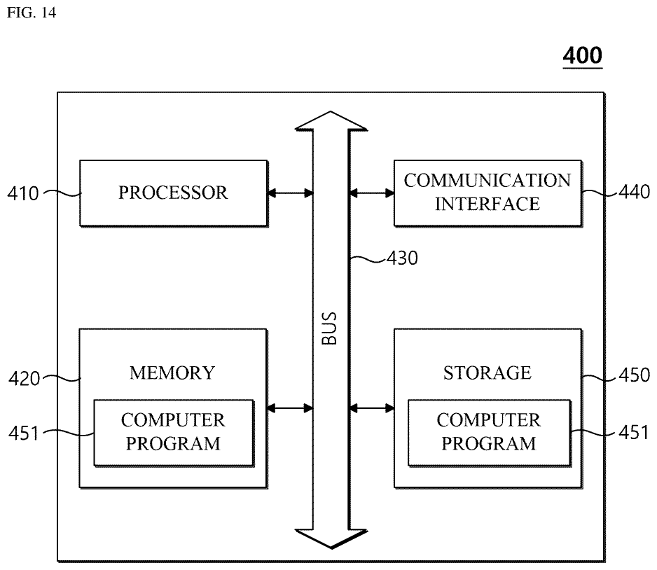

In various embodiments, the cat litter manufacturing system 1000 may further include a computing device 400 (see FIG. 14) that controls operations of the cat litter moisture coating device 100, the cat litter supply device 200, and the cat litter packaging device 300.

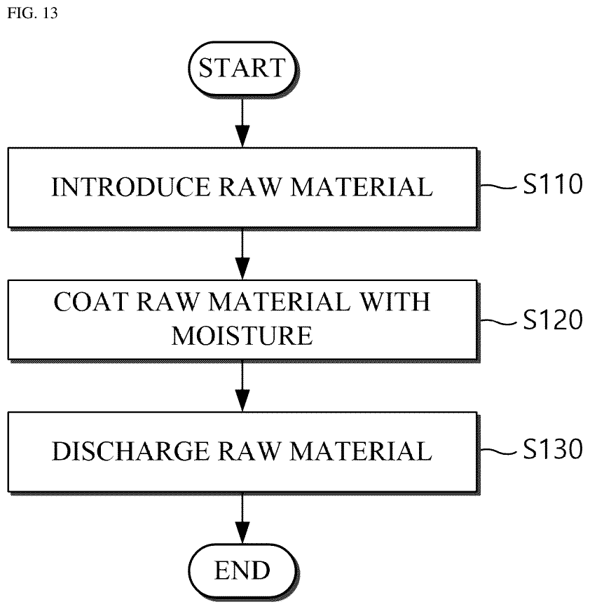

For example, the computing device 400 may control an operation of the raw material inlet 110 of the cat litter moisture coating device 100 to introduce a raw material into the moisture coating module 120, may control an operation of the moisture coating module 120 to coat the raw material with moisture, and may control an operation of the raw material outlet 130 to discharge the moisture-coated raw material to the outside. A method of coating cat litter with moisture using the cat litter moisture coating device 100 will be described below with reference to FIG. 13.

FIG. 13 is a flowchart for describing a method of coating cat litter with moisture according to another embodiment of the present invention.

The method of coating cat litter with moisture that will be described with reference to FIG. 13 is performed through the cat litter moisture coating device 100, and the cat litter moisture coating device 100 may perform the method of coating cat litter with moisture by performing various operations according to a control command obtained from the computing device 400.

Here, the computing device 400 may be a component that is provided outside the cat litter moisture coating device 100 and controls an operation from outside the cat litter moisture coating device 100, that is, a server that operates the cat litter manufacturing system, but the present invention is not limited thereto, and the computing device 400 may be a component that is provided in the cat litter moisture coating device 100 and controls various operations from inside the cat litter moisture coating device 100.

In step S110, a raw material is introduced into the cat litter moisture coating device 100.

In various embodiments, the computing device 400 may control an operation of the cat litter supply device 200 to supply the raw material and may allow the raw material to be introduced into the cat litter moisture coating device 100 through the raw material inlet 110 of the cat litter moisture coating device 100, but the present invention is not limited thereto.

In step S120, moisture coating is performed on the raw material introduced into the cat litter moisture coating device 100.

In various embodiments, when the raw material is introduced into the moisture coating module 120 of the cat litter moisture coating device 100 through the raw material inlet 110 of the cat litter moisture coating device 100, the computing device 400 may control an operation of the moisture coating module 120 to simultaneously rotate the body portion 121 included in the moisture coating module 120 in a predetermined direction and spray water to the raw material introduced into the body portion 121 through the water spray portion 123 included in the moisture coating module 120.

At this time, the computing device 400 may determine a rotational speed of the body portion 121 based on the amount of raw material introduced into the body portion 121 and may rotate the body portion 121 in the predetermined direction according to the determined rotational speed. However, the present invention is not limited thereto, and the computing device 400 may, based on a discharge amount per hour of the raw material discharged through the raw material outlet 130 of the cat litter moisture coating device 100, determine the rotational speed within a range in which the discharge amount per hour does not exceed a predetermined reference discharge amount.

Here, the rotational speed of the body portion 121 may be determined based on a data value obtained based on a result of performing a test using equipment relatively smaller than the cat litter moisture coating device 100, but the present invention is not limited thereto.

In various embodiments, when the amount of raw material introduced into the body portion 121 of the moisture coating module 120 exceeds a reference introduction amount, the computing device 400 may allow moisture coating to be precisely performed on a large amount of raw material by repeatedly performing an operation of rotating the body portion 121 by a first magnitude in a first direction and then rotating the body portion 121 by a second magnitude in a second direction, which is the opposite direction of the first direction.

At this time, the first magnitude may be set as a magnitude that is larger than the second magnitude to allow the raw material in the body portion 121 to move toward the raw material outlet 130, but the present invention is not limited thereto.

In various embodiments, by rotating the body portion 121 in the predetermined direction, the computing device 400 may guide the raw material introduced into the body portion 121 through the guide portion 122 provided on the inner side surface of the body portion 121 to move toward the raw material outlet 130.

For example, by rotating the body portion 121 in the predetermined direction, the computing device 400 may guide the raw material introduced into the body portion 121 to move along the movement path formed by the first guide portion 122A.

In another example, by rotating the body portion 121 in the predetermined direction, the computing device 400 may guide the raw material moving along the movement path formed by the first guide portion 122A to be appropriately mixed by the second guide portion 122B, that is, guide the moisture-coated raw material to be naturally mixed with the raw material not coated with moisture.

In various embodiments, the computing device 400 may spray water supplied from the water supply portion 123A included in the water spray portion 123 to the inside of the body portion 121 through the nozzle 123D.

In various embodiments, the computing device 400 may expand the spray range of water by spraying the water supplied from the water supply portion 123A included in the water spray portion 123 and the air supplied from the air supply portion 123B together. At this time, the computing device 400 may determine the water supply amount of the water supply portion 123A and the air supply amount of the air supply portion 123B based on the type and introduced amount of the raw material introduced into the body portion 121, but the present invention is not limited thereto.

In various embodiments, the computing device 400 may adjust an angle of the nozzle 123D so that water is sprayed in a direction perpendicular to the raw material introduced into the body portion 121.

In step S130, the raw material coated with moisture through the cat litter moisture coating device 100 is discharged to the outside.

In various embodiments, the computing device 400 may determine that the raw material is remaining in the body portion 121 from comparing the amount of raw material introduced through the raw material inlet 110 and the amount of raw material discharged through the raw material outlet 130, and accordingly, may spray the air supplied from the air supply portion 123B through the nozzle 123D to allow the raw material present in the body portion 121 to be smoothly discharged.

More specifically, first, the computing device 400 may calculate an estimated discharge amount (for example, an estimated weight of the raw material when moisture coating is appropriately performed on the raw material) based on the amount of raw material introduced through the raw material inlet 110.

Then, the computing device 400 may determine whether the raw material is remaining in the body portion 121 from comparing the calculated estimated discharge amount and the actual discharge amount discharged through the raw material outlet 130. For example, the computing device 400 may determine that the raw material is remaining in the body portion 121 when a difference between the estimated discharge amount and the actual discharge amount deviates from a predetermined error range, but the present invention is not limited thereto.

Then, when it is determined that the raw material is remaining in the body portion 121, the computing device 400 may spray the air supplied from the air supply portion 123B through the nozzle 123D to remove the raw material remaining in the body portion 121.

Here, after spraying only the air supplied from the air supply portion 123B to the inside of the body portion 121 through the nozzle 123D for a predetermined amount of time, the computing device 400 may re-compare the estimated discharge amount and the actual discharge amount discharged through the raw material outlet 130, and when the difference between the estimated discharge amount and the actual discharge amount deviates from the predetermined error range again, the computing device 400 may determine that moisture coating has not been appropriately performed on the raw material, and accordingly, may re-perform moisture coating on the raw material discharged through the raw material outlet 130.

To this end, the cat litter moisture coating device 100 may further include a moving member (for example, a conveyor) that connects the raw material outlet 130 and the raw material inlet 110, transports the raw material discharged from the raw material outlet 130 to the raw material inlet 110, and re-introduces the raw material into the moisture coating module 120, but the present invention is not limited thereto.

The above-described method of coating cat litter with moisture has been described with reference to the flowchart illustrated in the drawing. Although the method of coating cat litter with moisture has been described with reference to the illustrated series of blocks for convenience of description, the present invention is not limited to the illustrated order of the blocks, and some blocks may be performed in a different order from the order illustrated and described herein or may be simultaneously performed. In addition, a new block that has not been described and illustrated in the present specification and the drawings may be added, or some blocks may be omitted or modified. A hardware configuration of the computing device 400 that performs the method of coating cat litter with moisture will be described below with reference to FIG. 14.

FIG. 14 is a view illustrating a hardware configuration of a computing device according to still another embodiment of the present invention.

Referring to FIG. 14, in various embodiments, the computing device 400 may include one or more processors 410, a memory 420 for loading a computer program 451 run by the processors 410, a bus 430, a communication interface 440, and a storage 450 storing the computer program 451. Here, only the components related to the embodiment of the present invention are illustrated in FIG. 14. Therefore, those of ordinary skill in the art to which the present invention pertains should understand that the computing device 400 may further include other universal components in addition to the components illustrated in FIG. 14.

The processors 410 control the overall operation of each component of the computing device 400. The processors 410 may be configured to include a central processing unit (CPU), a microprocessor unit (MPU), a microcontroller unit (MCU), a graphic processing unit (GPU), or any other form of processor well known in the art to which the present invention pertains.

In addition, the processors 410 may perform an arithmetic operation on at least one application or program for executing the method according to embodiments of the present invention, and the computing device 400 may have one or more processors.

In various embodiments, the processors 410 may further include a random access memory (RAM) (not illustrated) and a read-only memory (ROM) (not illustrated) that temporarily and/or permanently store signals (or data) processed in the processors 410. In addition, the processors 410 may be implemented in the form of a System on Chip (SoC) including at least one of the GPU, the RAM, and the ROM.

The memory 420 stores various data, commands, and/or information. The memory 420 may load the computer program 451 from the storage 450 to execute the method/operations according to various embodiments of the present invention. When the computer program 451 is loaded to the memory 420, the processors 410 may execute one or more instructions constituting the computer program 451, thereby performing the method/operations. The memory 420 may be implemented as a volatile memory such as a RAM, but the technical scope of the present invention is not limited thereto.

The bus 430 provides a communication function between components of the computing device 400. The bus 430 may be implemented as any of buses of various forms such as an address bus, a data bus, and a control bus.

The communication interface 440 supports wired/wireless Internet communication of the computing device 400. In addition, the communication interface 440 may support various communication methods other than the Internet communication. To this end, the communication interface 440 may be configured to include a communication module well known in the art to which the present invention pertains. In some embodiments, the communication interface 440 may be omitted.

The storage 450 may non-provisionally store the computer program 451. When a process of coating cat litter with moisture is performed through the computing device 400, the storage 450 may store various information necessary to provide the process of coating cat litter with moisture.

The storage 450 may be configured to include a nonvolatile memory such as a ROM, an erasable programmable ROM (EPROM), an electrically erasable programmable ROM (EEPROM), and a flash memory, a hard disk, a removable disk, or any other form of computer-readable recording medium well known in the art to which the present invention pertains.

The computer program 451 may include one or more instructions that allow the processors 410 to perform the method/operations according to various embodiments of the present invention when the computer program 451 is loaded to the memory 420. That is, by executing the one or more instructions, the processors 410 may perform the method/operations according to various embodiments of the present invention.

In one embodiment, the computer program 451 may include one or more instructions that allow performing the method of coating cat litter with moisture that includes introducing a raw material through a raw material inlet included in a cat litter moisture coating device, coating the introduced raw material with moisture by spraying water thereto through a moisture coating module included in the cat litter moisture coating device, and discharging the moisture-coated raw material through a raw material outlet included in the cat litter moisture coating device.

The steps of the method or algorithm described in relation to the embodiments of the present invention may be directly implemented by hardware, may be implemented by a software module executed by hardware, or may be implemented by a combination thereof. The software module may reside in a RAM, a ROM, an EPROM, an EEPROM, a flash memory, a hard disk, a removable disk, a CD-ROM, or any other form of computer-readable recording medium well known in the art to which the present invention pertains.

The components of the present invention may be implemented as a program (or application) and stored in a medium so as to be executed in combination with a computer which is hardware. The components of the present invention may be executed by software programming or software elements, and similarly, embodiments may be implemented in a programming or scripting language, such as C, C++, Java, assembler, etc., to include various algorithms which are embodied as combinations of data structures, processes, routines, or other programming elements. Functional aspects may be implemented as an algorithm executed by one or more processors.

Embodiments of the present invention have been described above with reference to the accompanying drawings, but those of ordinary skill in the art to which the present invention pertains should understand that the present invention may be embodied in other specific forms without changing the technical spirit or essential features of the present invention. Therefore, the embodiments described above should be understood as being illustrative, instead of limiting, in all aspects.

1. A device for coating cat litter with moisture, the device comprising:
a raw material inlet;
a raw material outlet; and
a moisture coating module,
wherein, when a raw material is introduced into the moisture coating module through the raw material inlet, the introduced raw material is coated with moisture by water sprayed thereto through the moisture coating module, and the moisture-coated raw material is discharged through the raw material outlet.

2. The device of claim 1, wherein the moisture coating module includes:
a body portion having a cylindrical shape and of which one side is connected to the raw material inlet and the other side is connected to the raw material outlet;
a guide portion that is provided on an inner side surface of the body portion and guides the raw material introduced into the body portion toward the raw material outlet; and
a water spray portion that is inserted into the body portion and sprays water to the raw material introduced into the body portion.

3. The device of claim 2, wherein the body portion rotates in a predetermined direction, and a rotational speed of the body portion is determined based on an amount of the raw material introduced into the body portion.

4. The device of claim 2, wherein:
the guide portion includes a first guide portion that is provided on the inner side surface of the body portion and has a helical blade shape, thereby forming a movement path of the raw material introduced into the body portion; and
in response to the body portion rotating in the predetermined direction, the first guide portion guides the raw material introduced into the body portion toward the raw material outlet along the formed movement path.

5. The device of claim 4, wherein:
the guide portion further includes a second guide portion that is provided on the inner side surface of the body portion, is disposed on the formed movement path, and has a shape that is tilted a predetermined angle based on a center of the body portion; and
in response to the body portion rotating in the predetermined direction, the second guide portion guides mixing of the raw material moving along the formed movement path.

6. The device of claim 2, wherein the water spray portion includes:
a water supply portion;
a valve for controlling a water supply amount of the water supply portion; and
a nozzle for spraying water supplied from the water supply portion to an interior of the body portion.

7. The device of claim 6, wherein:
the water spray portion further includes an air supply portion;
air supplied through the air supply portion and water supplied through the water supply portion are sprayed through the nozzle, thereby expanding a spray range of the water; and
a supply amount of the water supplied through the water supply portion and a supply amount of the air supplied through the air supply portion are determined based on a type and an introduced amount of the raw material introduced into the body portion.

8. The device of claim 6, wherein:
the water spray portion further includes an air supply portion; and
when a difference between an amount of the raw material introduced through the raw material inlet and an amount of the raw material discharged through the raw material outlet exceeds a predetermined threshold value, air supplied from the air supply portion is sprayed through the nozzle.

9. The device of claim 6, wherein the nozzle has an angle-adjustable structure and sprays water in a direction perpendicular to the raw material introduced into the body portion.

10. The device of claim 1, wherein the moisture coating module includes:
a body portion having a cylindrical shape and of which one side is connected to the raw material inlet and the other side is connected to the raw material outlet; and
a plurality of water spray portions that are inserted into the body portion and spray water to the raw material introduced into the body portion, and
the plurality of water spray portions are continuously arranged while intersecting each other in the body portion, thereby expanding a spray range of the water.
